(19) United States
(12) Patent Application Publication
(10) Pub. No.: US 2021/0021617 A1
(43) Pub. Date: Jan. 21, 2021

(54) SUSPICIOUS MAIL DETECTION DEVICE, SUSPICIOUS MAIL DETECTION METHOD, AND COMPUTER READABLE MEDIUM

(71) Applicant: MITSUBISHI ELECTRIC CORPORATION, Tokyo (JP)

(72) Inventors: Hiroki NISHIKAWA, Tokyo (JP); Takumi YAMAMOTO, Tokyo (JP); Kiyoto KAWAUCHI, Tokyo (JP)

(73) Assignee: MITSUBISHI ELECTRIC CORPORATION, Tokyo (JP)

(21) Appl. No.: 17/031,998

(22) Filed: Sep. 25, 2020

Related U.S. Application Data
(63) Continuation of application No. PCT/JP2018/021247, filed on Jun. 1, 2018.

(51) Int. Cl. H04L 29/06

(52) U.S. Cl. CPC H04L 63/1416

(57) ABSTRACT

An operation unit (120) calculates a feature quantity of an object mail which is an email to be tested. Then, the operation unit acquires, based on the feature quantity of the object mail, a status identifier of the object mail from a status definition file. Then, the operation unit selects a mail thread which the object mail belongs to, from one mail thread or more as an object thread, and adds the status identifier of the object mail to a status group of the object thread. Then, the operation unit decides whether the status group, to which the status identifier of the object mail has been added, of the object thread complies with a detection rule. When the status group of the object thread complies with the detection rule, the operation unit produces an alert.

### CROSS REFERENCE TO RELATED APPLICATIONS

This application is a Continuation of PCT International Application No. PCT/JP2018/021247 filed on Jun. 1, 2018, which is hereby expressly incorporated by reference into the present application.

### TECHNICAL FIELD

The present invention relates to a technique for detecting a suspicious email.

### BACKGROUND ART

Targeted attacks have become a serious threat. Targeted attacks are attacks that target a particular organization or a particular person to conduct, for example, theft or the like of confidential information.

Among the targeted attacks, targeted mail attacks remain one of the most serious threats. Targeted mail attacks are email-based attacks.

According to a Trend Micro study, malware infections by targeted mail attacks account for as many as 76 percent of all attacks against businesses. Therefore, preventing targeted mail attacks is important from the perspective of preventing sophisticated cyber attacks that increase damages.

With this background, technologies to prevent organizations from targeted mail attacks by detecting targeted mail attacks have been studied.

Patent Literature 1 discloses a technique of determining whether an incoming mail is a suspicious email by comparing a header of the incoming email with a learned legitimate header.

Patent Literature 2 discloses a technique of identifying a format of a file attached to an email in order to determine whether the file is suspicious, and deciding whether the identified format is an allowed one.

Patent Literature 3 discloses a technique of determining a new mail as a suspicious email when a similarity between header information of the new mail and header information of a past mail is low.

Patent Literature 4 discloses a technique of determining an incoming mail as a suspicious email when a similarity between a body of the incoming mail and a body of a spam message exceeds a threshold.

Non-Patent Literature 1 will be referred to in Embodiments.

### CITATION LIST

### Patent Literature

Patent Literature 1: JP 2013-236308 A
Patent Literature 2: JP 2008-546111 A
Patent Literature 3: JP 2014-102708 A
Patent Literature 4: JP 2007-503660 A

### Non-Patent Literature

Non-Patent Literature 1: Mikolov, Tomas, et al. “Efficient estimation of word representations in vector space.”, arXiv preprint arXiv:1301.3781 (2013)

### SUMMARY OF INVENTION

### Technical Problem

It can happen that an attacker disguises a mail header to look like a legitimate header, and further devises a body of the mail as if it had been written by a target party. An existing technology is unable to detect such a sophisticated targeted attack mail.

For example, an attacker could infect a terminal of someone associated with the target and then use that person as a springboard to infect a terminal of the target. Specifically, using information (for example, email address) of the person to employ as a springboard, the attacker sends an attack mail to the terminal of the target. In this case, header information and so on of the attack mail are legitimate, and a body of the attack mail also has a characteristic of the person used as the springboard. Therefore, it is difficult to detect this attack mail with the existing technology.

There is a case where an attachment generated with a file format commonly used in organizations is used for the purpose of infection. In this case, if detection based on an extension of the attachment is attempted, its effect is limited.

Suppose an attack where, for example, in a query to a company's contact person about, for example, a product, an attacker gains credibility as someone who performs a normal transaction, and after that the attacker sends an attack mail that causes malware infection and so on. In this case, if the personal identity of the attack mail is verified, the mail cannot be detected as an attack mail since it is a mail sent from the person who has gained the credibility as a normal person.

The present invention has as its objective to enable detection of an attack mail as a suspicious mail based on a series of transactions performed prior to the attack mail, even when the attack mail cannot be detected per se alone as a suspicious mail.

### Solution to Problem

A suspicious mail detection device of the present invention includes:
a feature quantity calculation unit to calculate a feature quantity of an object mail which is an email to be tested;
a status acquisition unit to acquire, based on the feature quantity of the object mail, a status identifier of the object mail from a status definition file in which one status identifier or more and one feature quantity or more are associated with each other;
a thread construction unit to select a mail thread which the object mail belongs to, from one mail thread or more as an object thread, and to add the status identifier of the object mail to a status group of the object thread; and
a thread test unit to decide whether the status group, to which the status identifier of the object mail has been added, of the object thread complies with a detection rule expressing a status pattern in a mail thread which a suspicious mail belongs to.

### Advantageous Effects of Invention

According to the present invention, it is possible to detect an attack mail as a suspicious mail based on a series of transactions (a mail thread) performed prior to the attack mail, even when the attack mail cannot be detected per se alone as a suspicious mail.

### BRIEF DESCRIPTION OF DRAWINGS

FIG. 1 is a configuration diagram of a suspicious mail detection device 100 in Embodiment 1.

FIG. 2 is a configuration diagram of a preparation unit 110 in Embodiment 1.

FIG. 3 is a configuration diagram of an operation unit 120 in Embodiment 1.

FIG. 4 is a schematic diagram of a suspicious mail detection method in Embodiment 1.

FIG. 5 is a flowchart of the suspicious mail detection method in Embodiment 1.

FIG. 6 is a flowchart of a preparation process (S110) in Embodiment 1.

FIG. 7 is a diagram illustrating a status definition file 131 in Embodiment 1.

FIG. 8 is a flowchart of an operation process (S120) in Embodiment 1.

FIG. 9 is a flowchart of a thread test process (S127) in Embodiment 1.

FIG. 10 is a flowchart of a preparation process (S110) in Embodiment 2.

FIG. 11 is a flowchart of a thread construction process (S126) in Embodiment 2.

FIG. 12 is a hardware configuration diagram of the suspicious mail detection device 100 in the embodiments.

### DESCRIPTION OF EMBODIMENTS

In the embodiments and drawings, the same elements or equivalent elements are denoted by the same reference sign. Description of an element denoted by the same reference sign as a described element will be appropriately omitted or simplified. Arrows in the drawings mainly illustrate data flows or processing flows.

### Embodiment 1

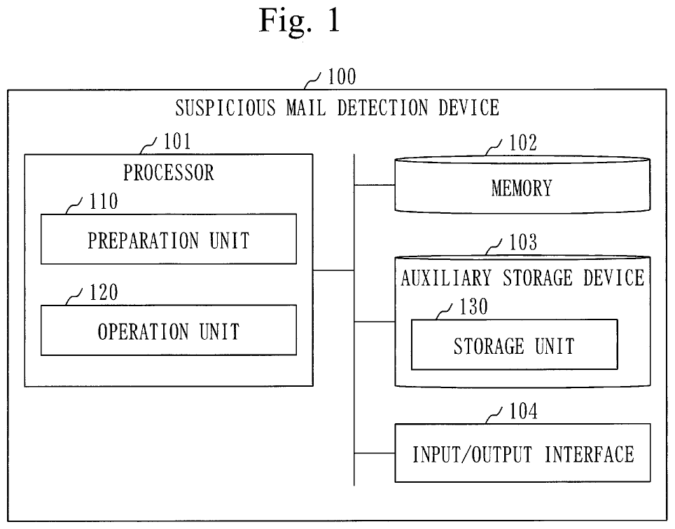

An embodiment of detecting a suspicious email will be described with referring to FIGS. 1 to 9.

***Description of Configuration***

A configuration of a suspicious mail detection device 100 will be described with referring to FIG. 1.

The suspicious mail detection device 100 is a computer provided with hardware devices such as a processor 101, a memory 102, an auxiliary storage device 103, and an input/output interface 104. These hardware devices are connected to each other via signal lines.

The processor 101 is an Integrated Circuit (IC) which performs computation processing, and controls the other hardware devices. For example, the processor 101 is a Central Processing Unit (CPU), a Digital Signal Processor (DSP), or a Graphics Processing Unit (GPU).

The memory 102 is a volatile storage device. The memory 102 is also called a main storage device or a main memory. For example, the memory 102 is a Random-Access Memory (RAM). Data stored in the memory 102 is saved in the auxiliary storage device 103 as necessary.

The auxiliary storage device 103 is a non-volatile storage device. For example, the auxiliary storage device 103 is a Read-Only Memory (ROM), a Hard Disk Drive (HDD), or a flash memory. Data stored in the auxiliary storage device 103 is loaded in the memory 102 as necessary.

The input/output interface 104 is a port to which an input device and an output device are connected. For example, the input/output interface 104 is a USB terminal. Note that USB stands for Universal Serial Bus. For example, the input device includes a keyboard, a mouse, and a receiver, and the output device includes a display and a transmitter. The receiver and the transmitter are collectively called a communication device.

The suspicious mail detection device 100 is provided with elements such as a preparation unit 110 and an operation unit 120. These elements are implemented by software.

A suspicious mail detection program is stored in the auxiliary storage device 103, to cause the computer to function as the preparation unit 110 and the operation unit 120. The suspicious mail detection program is loaded in the memory 102 and executed by the processor 101.

Also, an Operating System (OS) is stored in the auxiliary storage device 103. The OS is at least partly loaded in the memory 102 and executed by the processor 101.

That is, the processor 101 executes the suspicious mail detection program while executing the OS.

Data obtained by executing the suspicious mail detection program is stored in a storage device such as the memory 102, the auxiliary storage device 103, a register in the processor 101, and a cache memory in the processor 101.

The auxiliary storage device 103 functions as a storage unit 130. However, another storage device may function as the storage unit 130 in place of the auxiliary storage device 103 or along with the auxiliary storage device 103.

The suspicious mail detection device 100 may be provided with a plurality of processors that substitute for the processor 101. The plurality of processors share a role of the processor 101.

The suspicious mail detection program can be computer readably recorded (stored) in a non-volatile recording medium such as an optical disk and a flash memory.

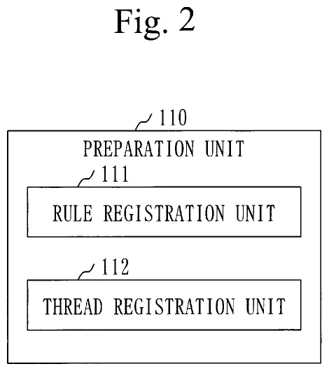

A configuration of the preparation unit 110 will be described with referring to FIG. 2.

The preparation unit 110 is provided with a rule registration unit 111 and a thread registration unit 112.

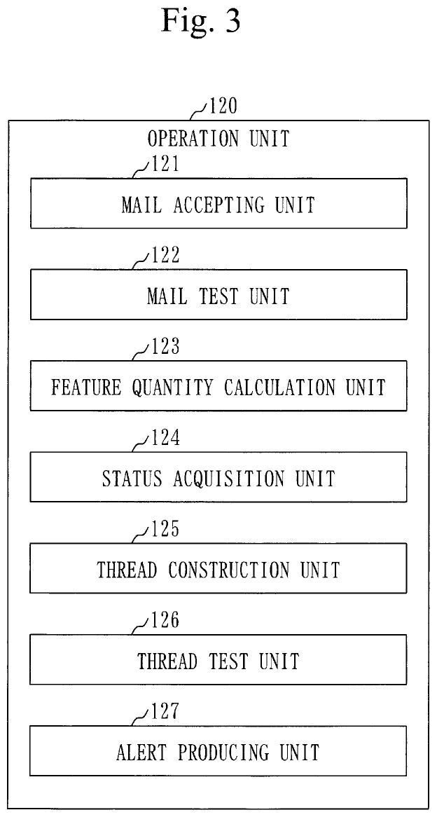

A configuration of the operation unit 120 will be described with referring to FIG. 3.

The operation unit 120 is provided with a mail accepting unit 121, a mail test unit 122, a feature quantity calculation unit 123, a status acquisition unit 124, a thread construction unit 125, a thread test unit 126, and an alert producing unit 127.

***Description of Operations***

Operations of the suspicious mail detection device 100 correspond to a suspicious mail detection method. Also, a procedure of the suspicious mail detection method corresponds to a procedure of the suspicious mail detection program.

The suspicious mail detection device 100 operates as, for example, an add-on of a mail client.

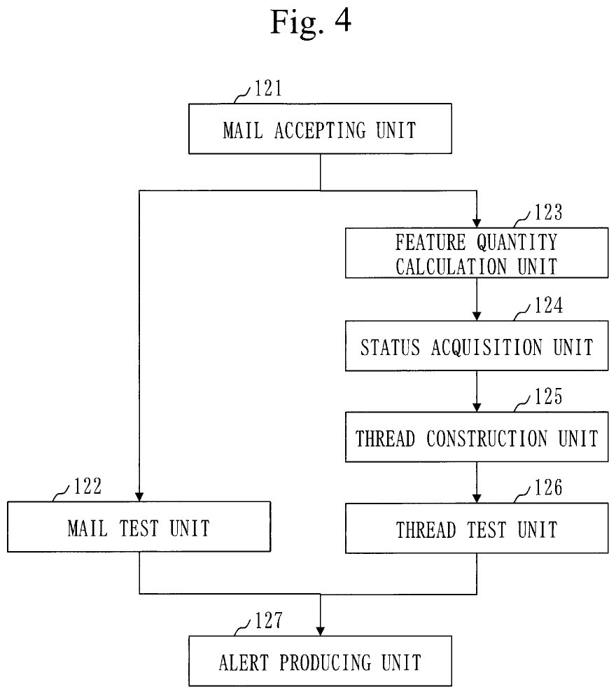

An outline of the suspicious mail detection method will be described with referring to FIG. 4.

The mail accepting unit 121 accepts an email to be tested.

An email to be tested will be called an object mail.

The mail test unit 122 decides whether the object mail satisfies a single requirement.

A single requirement is a condition an email corresponding to a suspicious mail satisfies alone.

A suspicious mail is a suspicious email. For example, a suspicious mail is an email supposed to be a targeted attack mail. A targeted attack mail is an email for conducting a targeted mail attack.

When the object mail satisfies the single requirement, the alert producing unit 127 produces an alert.

The feature quantity calculation unit 123 calculates a feature quantity of the object mail.

The feature quantity includes one value or more that express a feature of an email.

Based on the feature quantity of the object mail, the status acquisition unit 124 acquires a status identifier of the object mail from a status definition file.

The status definition file is a file in which one status identifier or more and one feature quantity or more are associated with each other.

The status identifier identifies a status corresponding to the feature quantity of the email.

The thread construction unit 125 selects a mail thread which the object mail belongs to, from one mail thread or more. The mail thread to be selected is called an object thread.

The thread construction unit 125 adds the status identifier of the object mail to a status group of the object thread.

The mail thread is a set of emails. The mail thread includes a mail group and a status group.

The mail group is one email or more which constitute a series of email transactions.

The status group is one status identifier or more of one email or more included in the mail group.

The thread test unit 126 decides whether the status group of the object thread, to which the status identifier of the object mail has been added, complies with a detection rule.

The detection rule expresses a status pattern in a mail thread which a suspicious mail belongs to.

The status pattern is a pattern about a status group, which the suspicious mail belongs to, of the mail thread.

Specifically, when the object mail does not satisfy the single requirement, the thread test unit 126 decides whether the status group of the object thread, to which the status identifier of the object mail has been added, complies with the detection rule.

If the status group of the object thread complies with the detection rule, the alert producing unit 127 produces an alert.

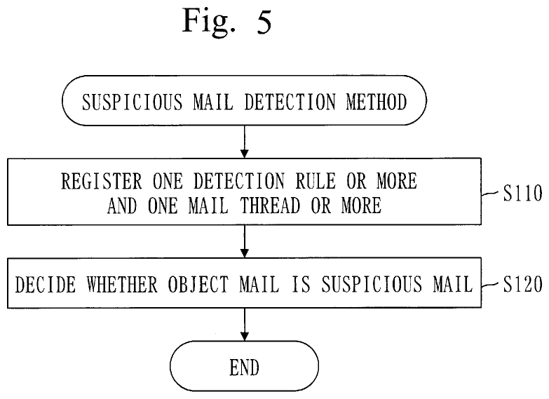

A processing flow in the suspicious mail detection method will be described with referring to FIG. 5.

In step S110, the preparation unit 110 registers one detection rule or more and one mail thread or more.

A preparation process (S110) in detail will be described later.

In step S120, the operation unit 120 decides whether the object mail is a suspicious mail.

An operation process (S120) in detail will be described later.

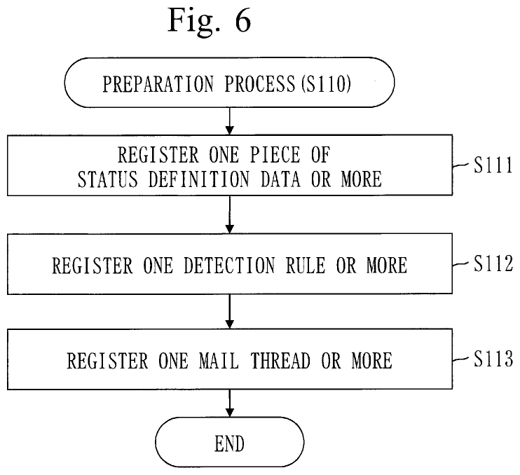

The preparation process (S110) will be described with referring to FIG. 6.

In step S111, a user generates one piece of status definition data or more based on various types of emails. The user then inputs the one piece of status definition data or more to the suspicious mail detection device 100.

The rule registration unit 111 accepts the one piece of status definition data or more. Then, the rule registration unit 111 registers the one piece of status definition data or more to the status definition file. The status definition file is stored in the storage unit 130.

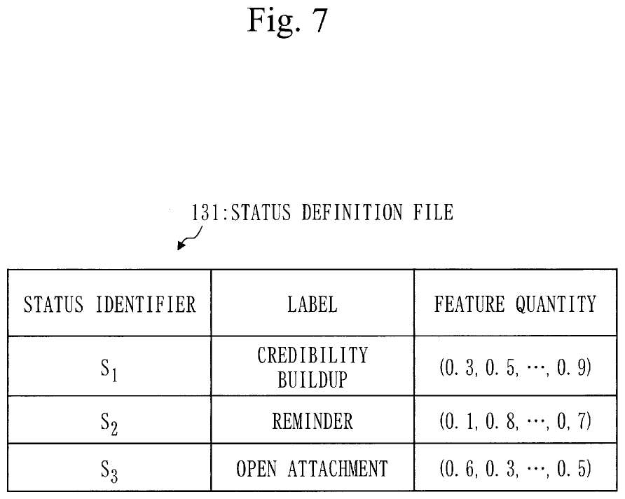

A status definition file 131 will be described with referring to FIG. 7.

The status definition file 131 is a specific example of the status definition file.

The status definition file 131 has three pieces of status definition data.

The status definition data includes a suite of a status identifier, a label, and a feature quantity. That is, the status definition data is data in which a status identifier, a label, and a feature quantity are associated with each other.

The status identifier identifies a status corresponding to the feature quantity of the email. Note that sx identifies an xth status.

The label expresses a status corresponding to the feature quantity of the email. Credibility buildup, reminder, and open attachment are examples of the label.

The feature quantity is one value or more expressing a feature of the email. For example, the feature quantity is a feature quantity vector. The feature quantity vector includes a plurality of values.

The user generates the status definition data as follows.

The user calculates a feature quantity of an email related to a particular status. Specifically, using the computer, and taking a body of the email as input, the user executes a feature quantity calculation tool. The feature quantity calculation tool calculates the feature quantity by an existing technique. A specific example of the existing technique is Word2vec. Non-Patent Literature 1 is a literature about Word2Vec. With applying the Word2Vec, a distributed representation can be extracted from the body of the email, and the extracted distributed representation can be expressed by a feature vector.

The user determines a status identifier identifying the particular status. The user also determines a label indicating the particular status.

Then, by setting the status identifier, the label, and the feature quantity, the user generates status definition data.

Back to FIG. 6, the description continues from step S112.

In step S112, the user generates one detection rule or more based on one piece of status definition data or more. The user then inputs the one detection rule or more to the suspicious mail detection device 100.

Specifically, using the one status identifier or more as one word or more, the user describes the detection rule in a regular expression.

The rule registration unit 111 accepts the one detection rule or more. Then, the rule registration unit 111 registers the one detection rule or more to a detection rule file. The detection rule file is stored in the storage unit 130.

In step S113, the thread registration unit 112 generates one mail thread or more. Then, the thread registration unit 112 registers the one mail thread or more to a thread database. The thread database is stored in the storage unit 130.

The thread registration unit 112 generates the one mail thread or more as follows.

First, the thread registration unit 112 groups a plurality of communicated emails based on their individual header information. The header information is information included in a header of an email. Specifically, the header information is information such as Message-Id, In-Reply-To, and References.

Subsequently, the thread registration unit 112 calculates the feature quantity per email. The feature quantity is calculated in the manner described above. That is, the thread registration unit 112 calculates a feature quantity of each email by the existing technique such as Word2Vec.

Subsequently, based on the feature quantity of the email, the thread registration unit 112 acquires, per email, the status identifier of the email from the status definition file. Specifically, the thread registration unit 112 selects a feature quantity the closest to the feature quantity of the email from the status definition file, and acquires a status identifier associated with the selected feature quantity from the status definition file. The status identifier to be acquired is the status identifier of the email.

Then, the thread registration unit 112 generates, per mail group, a mail thread including a mail group and a status group.

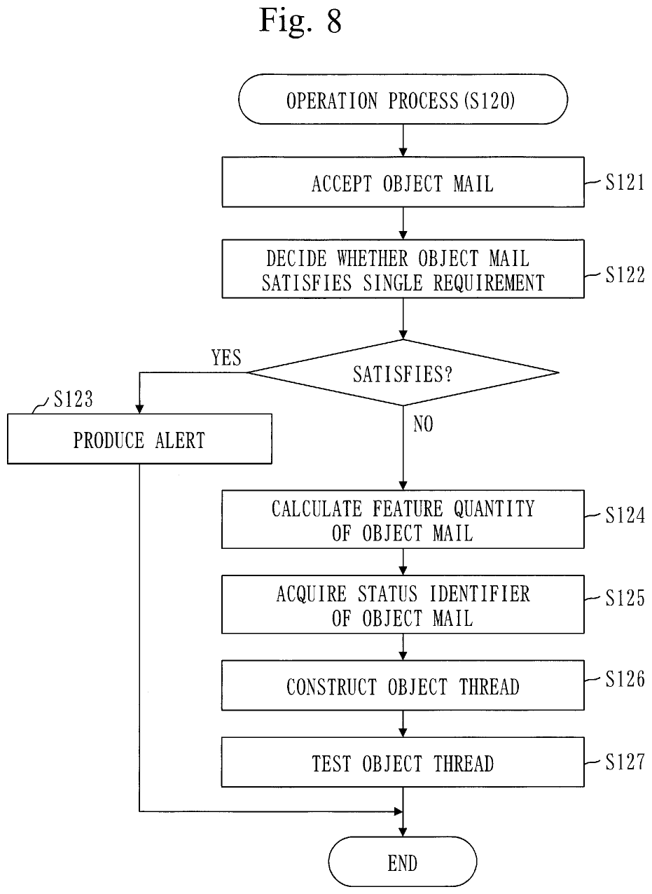

The operation process (S120) will be described with referring to FIG. 8.

In step S121, the mail accepting unit 121 accepts an email to be tested. The email to be accepted will be referred to as an object mail.

For example, the mail accepting unit 121 accepts the object mail from a mail system. A practical example of the mail system is a mail server or a mail client.

In step S122, the mail test unit 122 decides whether the object mail (particularly header information) satisfies the single requirement.

For example, the mail test unit 122 performs surface analysis of the object mail.

For example, the mail test unit 122 decides whether the object mail corresponds to a suspicious mail by a method disclosed in any one of Patent Literature 1 to Patent Literature 4. If the object mail corresponds to a suspicious mail, the object mail satisfies the single requirement.

If the object mail satisfies the single requirement, the processing proceeds to step S123.

If the object mail does not satisfy the single requirement, the processing proceeds to step S124.

In step S123, the alert producing unit 127 produces an alert.

For example, the alert producing unit 127 displays an alert message on the display. The alert message notifies occurrence of a suspicious email (object mail).

In step S124, the feature quantity calculation unit 123 calculates a feature quantity of the object mail.

Specifically, the feature quantity calculation unit 123 calculates the feature quantity of the object mail by an existing technique such as Word2Vec.

In step S125, the status acquisition unit 124 acquires a status identifier of the object mail from the status definition file based on the feature quantity of the object mail.

Specifically, the status acquisition unit 124 selects a feature quantity the closest to the feature quantity of the object mail from the status definition file. Then, the status acquisition unit 124 acquires a status identifier associated with the selected feature quantity from the status definition file.

In step S126, the thread construction unit 125 constructs the object thread as follows.

First, the thread construction unit 125 searches the thread database so as to select a mail thread which the object mail belongs to, from the thread database. Specifically, per mail thread included in the thread database, the thread construction unit 125 decides whether the object mail belongs to the mail group, based on the header information of the object thread and the header information of the email included in the mail group. Then, the thread construction unit 125 selects a mail thread of the mail group which the object mail belongs to. The mail thread to be selected is the object thread. For example, the thread construction unit 125 decides whether a value of Message-Id in the object mail coincides with a value of In-Reply-To in the email included in the mail group, or a value of References in the email included in the mail group. If the value of Message-Id in the object mail coincides with the value of In-Reply-To in the email included in the mail group, or the value of References in the email included in the mail group, the object mail belongs to the mail group.

Then, the thread construction unit 125 adds the object mail to the object thread. Specifically, the thread construction unit 125 adds the object mail to the mail group of the object thread, and adds the status identifier of the object mail to the status group of the object thread.

In step S127, the thread test unit 126 tests the object thread.

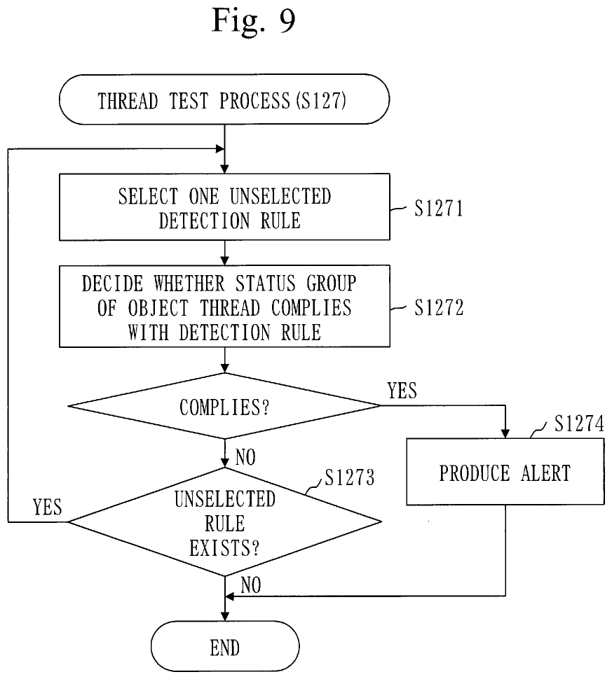

A thread test process (S127) will be described with referring to FIG. 9.

In step S1271, the thread test unit 126 selects one unselected detection rule from the detection rule file.

Step S1272 is executed for the detection rule selected in step S1261.

In step S1272, the thread test unit 126 decides whether the status group of the object thread complies with the detection rule.

Specifically, taking a detection rule r₁ and a status group t as input, the thread test unit 126 executes a matching function (r₁, t).

The detection rule r₁ is a detection rule selected in step S1261. Specifically, the detection rule r₁ is an ith detection rule.

The status group t is a status group of the object thread. The status group t is expressed by a series {sₐ₁, sₐ₂, . . . , s_{aN}} of a status identifier sⱼ where sₐₙ is a status identifier for an nth email in the series of email transactions.

The matching function (r₁, t) is a function for performing matching of a regular expression. When the matching function (r₁, t) is executed, a return value is obtained. The return value of the matching function (r₁, t) indicates whether or not the status group t complies with the detection rule r₁.

If the status group of the object thread complies with the detection rule, the processing proceeds to step S1274.

If the status group of the object thread does not comply with the detection rule, the processing proceeds to step S1273.

In step S1273, the thread test unit 126 decides whether an unselected detection rule exists. In step S1273, an unselected detection rule is referred to as an unselected rule.

If an unselected rule exists, the processing proceeds to step S1271.

If an unselected rule does not exist, the thread test process (S127) ends.

In step S1274, the alert producing unit 127 produces an alert.

For example, the alert producing unit 127 displays an alert message on the display. The alert message notifies occurrence of a suspicious email (object mail).

### Effect of Embodiment 1

Embodiment 1 is aimed at detecting a targeted attack mail having nothing suspicious in its header information and attachment, and a targeted attack mail having a body crafted so sophisticatedly that nothing suspicious can be sensed from just one targeted attack mail.

In Embodiment 1, when a mail is received, a transaction with a sender of the mail is extracted, and a mail accepted when an attack status has occurred is detected as a suspicious mail. This enables detection of a sophisticated targeted attack mail.

In Embodiment 1, when a malicious transaction is performed, even if surface information such as header information is natural information, a suspicions mail can be detected. As a result, a sophisticated targeted mail attack can be prevented.

In Embodiment 1, the detection rule is described with a regular expression. Therefore, the detection rule about a complicated transaction can be expressed simply.

For example, it is possible to simply express a detection rule for transactions where several times of repetition of mails having similar contents are followed by an attack, and a detection rule for transactions where a destination confirmation mail to gain credibility is followed by a reminder.

***Other Configurations***

The thread registration unit 112 may limit emails to be grouped.

For example, the thread registration unit 112 groups emails communicated after a particular time. By doing this, an excessively old transaction can be excluded.

For example, the thread registration unit 112 groups emails communicated by a particular communication terminal. By doing this, transactions of only a particular person can be monitored.

The thread registration unit 112 and the thread construction unit 125 may discard a mail thread that has passed a fixed period of time.

Specifically, the thread registration unit 112 sets a time to live for each mail thread. When the time to live has passed since registration or update (in a case where a mail is added), the thread registration unit 112 or the thread construction unit 125 discards this mail thread.

### Embodiment 2

Embodiment 1 described a mode in which a mail thread is registered in advance.

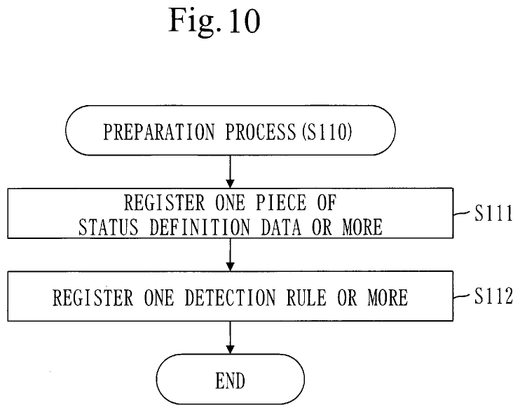

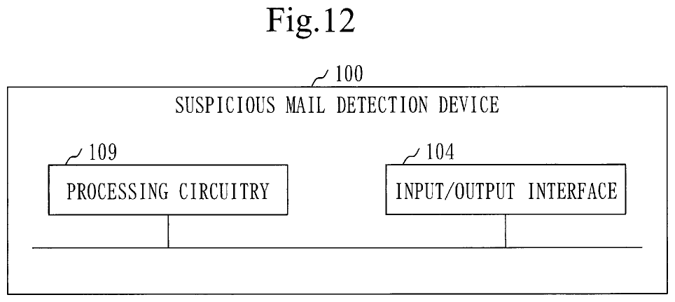

In Embodiment 2, a mode will be described in which a mail thread is registered as necessary, mainly regarding its difference from Embodiment 1 with referring to FIGS. 10 and 12.

***Description of Configuration***

A configuration of a suspicious mail detection device 100 is the same as a counterpart configuration in Embodiment 1 (see FIG. 1). However, a configuration of a preparation unit 110 is different from a counterpart configuration in Embodiment 1.

In Embodiment 1, the preparation unit 110 is provided with the rule registration unit 111 and the thread registration unit 112 (see FIG. 2). In Embodiment 2, however, no thread registration unit 112 is necessary.

***Description of Operations***

An outline of a suspicious mail detection method will be described with referring to FIG. 4.

Individual units in a line-up of a mail accepting unit 121 to a thread test unit 126 operate as described in Embodiment 1.

Furthermore, the thread construction unit 125 and the thread test unit 126 operate as follows.

When a mail thread which an object mail belongs to does not exist, the thread construction unit 125 generates a mail thread which the object mail belongs to, as an object thread. Then, the thread construction unit 125 adds a status identifier of the object mail to a status group of the generated object thread.

A processing flow of the suspicious mail detection method is the same as the counterpart flow in Embodiment 1 (see FIG. 5). However, a preparation process (S110) in detail and an operation process (S120) in detail are different from counterpart processes in Embodiment 1.

The preparation process (S110) will be described with referring to FIG. 10.

In step S111, a rule registration unit 111 registers one piece of status definition data or more to a status definition file. Step S111 is as having been described in Embodiment 1 (see FIG. 6).

In step S112, the rule registration unit 111 registers one detection rule or more to a detection rule file. Step S112 is as having been described in Embodiment 1 (see FIG. 6).

After step S112, the preparation process (S110) ends. Step S113 in Embodiment 1 is not needed in Embodiment 2.

A flow of the operation process (S120) is the same as the counterpart flow in Embodiment 1 (see FIG. 8). However, a thread construction process (S126) is different from the counterpart process in Embodiment 1.

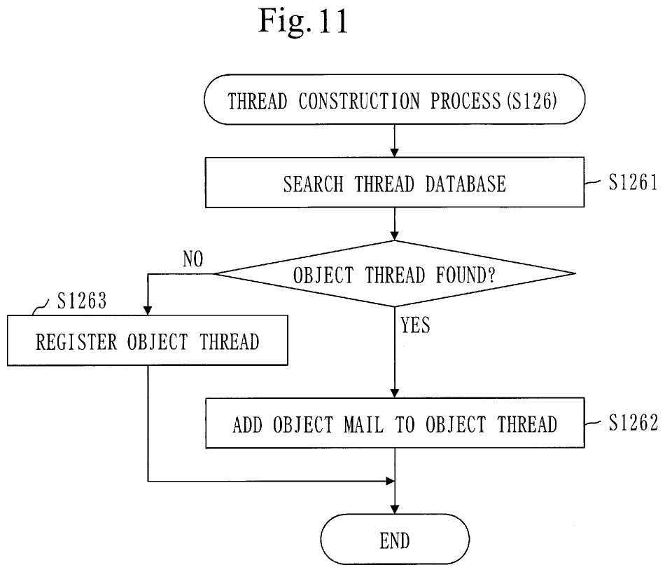

The thread construction process (S126) will be described with referring to FIG. 11.

In step S1261, the thread construction unit 125 searches a thread database in order to find the object thread.

If the object thread is found, the processing proceeds to step S1262.

If the object thread is not found, the processing proceeds to step S1263.

In step S1262, the construction unit 125 adds the object mail to the object thread.

Specifically, the thread construction unit 125 adds the object mail to a mail group of the object thread, and adds a status identifier of the object mail to the status group of the object thread.

In step S1263, the thread construction unit 125 registers the object thread to the thread database.

The object thread is registered as follows.

The mail accepting unit 121 requests from a mail system one email or more related to the object mail, based on the header information of the object mail. Then, the mail accepting unit 121 accepts one email or more related to the object mail, from the mail system. The accepted email is referred to as a related email.

The feature quantity calculation unit 123 calculates a feature quantity per related mail. Furthermore, the feature quantity calculation unit 123 calculates a feature quantity of the object mail.

The status acquisition unit 124 acquires a status identifier per related mail based on the feature quantity per related mail. Furthermore, the status acquisition unit 124 acquires the status identifier of the object mail based on the feature quantity of the object mail.

The thread construction unit 125 generates a new mail thread using the related mail and the status identifier of the related mail. The new mail thread includes a mail group of the related mail and a status group of the related mail. The mail thread to be generated is the object thread. The thread construction unit 125 registers the object thread to the thread database. Then, the thread construction unit 125 adds the object mail to the object thread. Specifically, the thread construction unit 125 adds the object mail to the mail group of the object thread, and adds the status identifier of the object mail to the status group of the object thread.

### Effect of Embodiment 2

By registering a mail thread as necessary, a useless transaction can be neglected, such as a transaction dated so long ago that it need not be taken into account, and a transaction whose discussion has been completed. Then, reduction of a storage capacity and a higher processing speed can be expected.

### Supplement to Embodiments

A hardware configuration of the suspicious mail detection device 100 will be described with referring to FIG. 12.

The suspicious mail detection device 100 is provided with processing circuitry 109.

The processing circuitry 109 is hardware that implements the preparation unit 110 and the operation unit 120.

The processing circuitry 109 may be dedicated hardware, or may be a processor 101 that executes the program stored in the memory 102.

When the processing circuitry 109 is dedicated hardware, the processing circuitry 109 is, for example, a single circuit, a composite circuit, a programmed processor, a parallel-programmed processor, an ASIC, or an FPGA; or a combination of a single circuit, a composite circuit, a programmed processor, a parallel-programmed processor, an ASIC, and an FPGA. Note that ASIC stands for Application Specific Integrated Circuit, and FPGA stands for Field Programmable Gate Array.

The suspicious mail detection device 100 may be provided with a plurality of processing circuitries that substitute for the processing circuitry 109. The plurality of processing circuitries share a role of the processing circuitry 109.

In the processing circuitry 109, some of the functions may be implemented by dedicated hardware, and the remaining functions may be implemented by software or firmware.

In this manner, the processing circuitry 109 can be implemented by hardware, software, or firmware; or a combination of hardware, software, and firmware.

Each embodiment is an exemplification of a preferred mode and is not intended to limit the technical scope of the present invention. The embodiment may be practiced partly, or in combination with another embodiment. The procedures described with using flowcharts and so on may be changed appropriately.

### REFERENCE SIGNS LIST

100: suspicious mail detection device; 101: processor; 102: memory; 103: auxiliary storage device; 104: input/output interface; 109: processing circuitry; 110: preparation unit; 111: rule registration unit; 112: thread registration unit; 120: operation unit; 121: mail accepting unit; 122: mail test unit; 123: feature quantity calculation unit; 124: status acquisition unit; 125: thread construction unit; 126: thread test unit; 127: alert producing unit; 130: storage unit; 131: status definition file.

1. A suspicious mail detection device comprising:
processing circuitry
to calculate a feature quantity of an object mail which is an email to be tested,
to acquire, based on the feature quantity of the object mail, a status identifier of the object mail from a status definition file in which one status identifier or more and one feature quantity or more are associated with each other,
to select a mail thread which the object mail belongs to, from one mail thread or more as an object thread, and to add the status identifier of the object mail to a status group of the object thread, and
to decide whether the status group, to which the status identifier of the object mail has been added, of the object thread complies with a detection rule expressing a status pattern in a mail thread which a suspicious mail belongs to.

2. The suspicious mail detection device according to claim 1, wherein
the processing circuitry decides whether the object mail satisfies a single requirement which an email corresponding to the suspicious mail satisfies alone.

3. The suspicious mail detection device according to claim 2,
wherein when the object mail does not satisfy the single requirement, the processing circuitry decides whether the status group of the object thread, to which the status identifier of the object mail has been added, complies with the detection rule.

4. The suspicious mail detection device according to claim 1,
wherein when a mail thread which the object mail belongs to does not exist, the processing circuitry generates a mail thread which the object mail belongs to, as an object thread, and adds the status identifier of the object mail to a status group of the generated object thread.

5. The suspicious mail detection device according to claim 2,
wherein when a mail thread which the object mail should belong to does not exist, the processing circuitry generates a mail thread which the object mail belongs to, as an object thread, and adds the status identifier of the object mail to a status group of the generated object thread.

6. The suspicious mail detection device according to claim 3,
wherein when a mail thread which the object mail should belong to does not exist, the processing circuitry generates a mail thread which the object mail belongs to, as an object thread, and adds the status identifier of the object mail to a status group of the generated object thread.

7. A suspicious mail detection method comprising:
calculating a feature quantity of an object mail which is an email to be tested;
based on the feature quantity of the object mail, a status identifier of the object mail from a status definition file in which one status identifier or more and one feature quantity or more are associated with each other;
selecting a mail thread which the object mail belongs to, from one mail thread or more as an object thread, and adding the status identifier of the object mail to a status group of the object thread; and
deciding whether the status group, to which the status identifier of the object mail has been added, of the object thread complies with a detection rule expressing a status pattern in a mail thread which a suspicious mail belongs to.

8. A non-transitory computer readable medium recorded with a suspicious mail detection program which causes a computer to execute:
a feature quantity calculation process of calculating a feature quantity of an object mail which is an email to be tested;
a status acquisition process of acquiring, based on the feature quantity of the object mail, a status identifier of the object mail from a status definition file in which one status identifier or more and one feature quantity or more are associated with each other;
a thread construction process of selecting a mail thread which the object mail belongs to, from one mail thread or more, as an object thread, and adding the status identifier of the object mail to a status group of the object thread; and
a thread test process of deciding whether the status group, to which the status identifier of the object mail has been added, of the object thread complies with a detection rule expressing a status pattern in a mail thread which a suspicious mail belongs to.
